(19) United States
(12) Patent Application Publication
(10) Pub. No.: US 2025/0033889 A1
(43) Pub. Date: Jan. 30, 2025

(54) SYSTEMS AND METHODS FOR PROCESSING OBJECTS INCLUDING COMMONLY LOCATED BIN INFEED AND DISCHARGE

(71) Applicant: Berkshire Grey Operating Company, Inc., Bedford, MA (US)

(72) Inventors: Jeffrey KITTREDGE, Lexington, MA (US); Mitchell GUILLAUME, Somerville, MA (US); Kirsten WANG, Maynard, MA (US); Jennifer Eileen KING, Oakmont, PA (US)

(21) Appl. No.: 18/783,593

(22) Filed: Jul. 25, 2024

Related U.S. Application Data
(60) Provisional application No. 63/529,419, filed on Jul. 28, 2023.

(51) Int. Cl. B65G 15/22; G06Q 50/04

(52) U.S. Cl. CPC B65G 15/22; G06Q 50/04; B65G 2201/0235

(57) ABSTRACT

An object processing system is disclosed that includes an infeed processing system including a source bin feed conveyor for providing source bins, a distribution system for receiving the source bins and for receiving a plurality of empty bins, and for providing objects from the source bins to a collection of processing locations, each processing location including an empty bin of the plurality of empty bins thereby providing the previously empty bins as processed bins when completed, and an outfeed processing system for moving the processed bins away from the collection of processing locations, wherein the empty bins and the processed bins are each positioned at some point in their respective output paths on a common out-feed conveyor.

### PRIORITY

The present application claims priority to U.S. Provisional Patent Application No. 63/529,419, filed Jul. 28, 2023, the disclosure of which is hereby incorporated by reference in its entirety.

### BACKGROUND OF THE INVENTION

The invention generally relates to automated programmable motion control systems, e.g., robotic, sortation and other processing systems, and relates in particular to programmable motion control systems intended for use in environments requiring that a variety of objects (e.g., articles, packages, parcels etc.) be processed and moved to a number of processing destinations.

In store-replenishment applications, for example, various models exist for replenishment. In a push model, cases of SKUs from an original manufacture arrive and need to be split across multiple stores for immediate distribution (hence sometimes called break-pack). In a pull model, items at stores have been ordered and the merchandiser wants to keep a minimum number of items on shelves, so they pull inventory from, e.g., AS/RS and distribute given SKU to stores that need them. Sometimes there is a mixture of push and pull models at distribution centers (DCs).

Conventional approaches to this problem involve manual or automated systems, or a mix of both. Commonly this work is done manually where workers distribute items in a case manually to multiple outgoing boxes corresponding to stores. Manual approaches are labor intensive. Automated approaches include the variety of available unit sorters such as cross-belt, tilt tray and bomb bay unit sorters. Unit sorters, however, have inherent problems, including introducing a single point of failure for a facility, as well as still requiring labor to service the outbound destinations. Such systems may require a large number of collection bins (and therefore a large amount of physical space, large investment costs, and large operating costs). Additionally, such break-pack systems must also monitor the volume of each like object in a bin, requiring that a human worker continuously count the items in a bin.

Further, current state-of-the-art processing systems also rely on human labor to some extent. Such solutions rely on a worker that is performing sortation, by scanning each object from an induction area (chute, table, etc.) and placing each object at a staging location, conveyor, or collection bin. More significantly, each destination must be serviced manually. When a bin is full, another worker empties the bin into a bag, box, or other container, and sends that container on to the next processing step. Such systems have limits on throughput.

There remains a need, therefore, for more efficient and more cost-effective object processing systems that overcome the limitations of 1) the existence of a single point of failure, 2) the labor required to service the destinations, and 3) the problem that multiple objects cannot be inducted onto the object carrier because the carrier is moving.

### SUMMARY OF THE INVENTION

In accordance with an aspect the invention provides an object processing system that includes an infeed processing system including a source bin feed conveyor for providing source bins, a distribution system for receiving the source bins and for receiving a plurality of empty bins, and for providing objects from the source bins to a collection of processing locations, each processing location including an empty bin of the plurality of empty bins thereby providing the previously empty bins as processed bins when completed, and an outfeed processing system for moving the processed bins away from the collection of processing locations, wherein the empty bins and the processed bins are each positioned at some point in their respective output paths on a common out-feed conveyor.

In accordance with another aspect, the invention provides an object processing system that includes a distribution system for receiving a plurality of source bins and for receiving a plurality of empty bins, and for providing objects from the source bins to a plurality of processing locations that each include an empty bin of the plurality of empty bins thereby providing the previously empty bins as processed bins when completed, wherein the plurality of processing locations is provided as at least two sets of collections of processing locations that are positioned on either side of the distribution system; and an outfeed processing system for moving the processed bins away from the plurality of processing locations, wherein the empty bins and the processed bins are each positioned at some point in their respective output paths on a common out-feed conveyor.

In accordance with a further aspect, the invention provides a method of processing objects that includes receiving a plurality of source bins at a distribution system, receiving a plurality of empty bins at the distribution system, providing objects from the source bins to a collection of processing locations, each processing location including an empty bin of the plurality of empty bins thereby providing the previously empty bins as processed bins when completed, and moving the processed bins away from the collection of processing locations, wherein the empty bins and the processed bins are each positioned at some point in their respective output paths on a common out-feed conveyor.

### BRIEF DESCRIPTION OF THE DRAWINGS

The following description may be further understood with reference to the accompanying drawings in which:

FIG. 1 shows an illustrative diagrammatic view of an object processing system in accordance with an aspect of the present invention;

FIG. 2 shows an illustrative diagrammatic view of the distribution system of the object processing system of FIG. 1;

FIGS. 3A and 3B show illustrative diagrammatic enlarged views of the distribution conveyor of the distribution system of FIG. 2 showing an object loaded onto the distribution conveyor (FIG. 3A) and being discharged from a carriage into a destination location (FIG. 3B);

FIGS. 4A and 4B show illustrative diagrammatic views of an empty bin being loaded showing the empty bin approaching a divert (FIG. 4A) and having been diverted onto a conveyor (FIG. 4B);

FIGS. 5A and 5B show illustrative diagrammatic views of a processed bin being discharged from processing location (FIG. 5A) and moved to a processed bin holding conveyor (FIG. 5B);

FIGS. 6A and 6B show illustrative diagrammatic views of a bin assembly including a bin, a tray and a box cover showing the bin assembly (FIG. 6A) and showing the assembly in exploded view (FIG. 6B);

FIG. 7 shows an illustrative functional diagram of a tote and bag fullness analysis program used in an object processing system in accordance with an aspect of the present invention;

FIGS. 8A and 8B show illustrative diagrammatic views of a processed bin being discharged onto a common outfeed conveyor (FIG. 8A) and subsequently to a processed bin conveyor (FIG. 8B);

FIG. 9 shows an illustrative diagrammatic view of diverts of the object processing system of FIG. 1 diverting empty bins and processed bins;

FIG. 10 shows an illustrative diagrammatic view of a portion of an object processing system in accordance with a further aspect of the present invention in which the empty bin feed conveyor is positioned outside of the processed bin feed conveyor;

FIG. 11 shows an illustrative diagrammatic view of an object processing system in accordance with a further aspect of the present invention that includes a programmable motion device;

FIG. 12 shows an illustrative diagrammatic view of an object processing system in accordance with a further aspect of the present invention that includes a common outfeed conveyor;

FIGS. 13A-13D show illustrative diagrammatic plan views of the common outfeed conveyor of FIG. 12 showing two empty bins being introduced (FIG. 13A), showing one empty bin being selected for transfer to a processing conveyor (FIG. 13B), showing a second empty bin being selected for transfer to another processing conveyor (FIG. 13C), and showing processed bins being moved onto the common outfeed conveyor (FIG. 13D);

FIG. 14 shows an illustrative diagrammatic view of an object processing system in accordance with a further aspect of the present invention that includes stacked processing and outfeed conveyors;

FIG. 15 shows an illustrative diagrammatic view of an object processing system in accordance with a further aspect of the present invention that includes plural processing stations on one side of the outfeed conveyors;

FIG. 16 shows an illustrative diagrammatic view of an object processing system in accordance with a further aspect of the present invention that includes plural processing stations on opposite sides of the outfeed conveyors; and

FIGS. 17A-17B show illustrative diagrammatic views of process flow steps in an object processing system in accordance with an aspect of the present invention.

The drawings are shown for illustrative purposes only.

### DETAILED DESCRIPTION OF THE INVENTION

In accordance with various aspects, systems of the invention provide object processing using a common out-feed conveyor that is used, at least in part, for moving empty and completed processing bins. The system arrangement (back discharging) includes a common portion of feed and take-away conveyor(s) at the back of the system. The front of the system is therefore left open having no crossing conveyor that restricts access to personnel for operation and maintenance of the system, avoiding potential safety hazards. Such a system does not include any front conveyor and provides thereby open access to the system via the now open front. The process of having dedicated feed and take-away lines at the rear of the station may be used, for example, when the outbound container flow exceeds the capacity of a single comingled take-away line.

Systems and processes in accordance with various aspects of the invention use re-entrance of containers (bins) onto the line of which they were delivered. The control systems manage the bin state and decisions are made when to control entrance or exit of the bin to/from the common conveyor. Systems also optimize the times these entrances and exits are performed, and monitor total system state to optimize queuing to minimize the effects of output peaks, slowdowns, machine down time machine service and other anomalies. Such processes increase overall system robustness with real-time management (orchestration) of decision points. The decisions processes self-adjust and optimize based on previously learned data sets, and monitor bins as they progress down the common feed/take-away conveyor to avoid the need scan and identify material mid-processing (and prior to further decision-making). Sensors may be used (as discussed herein) for error proofing, bin identification/confirmation, and error detection.

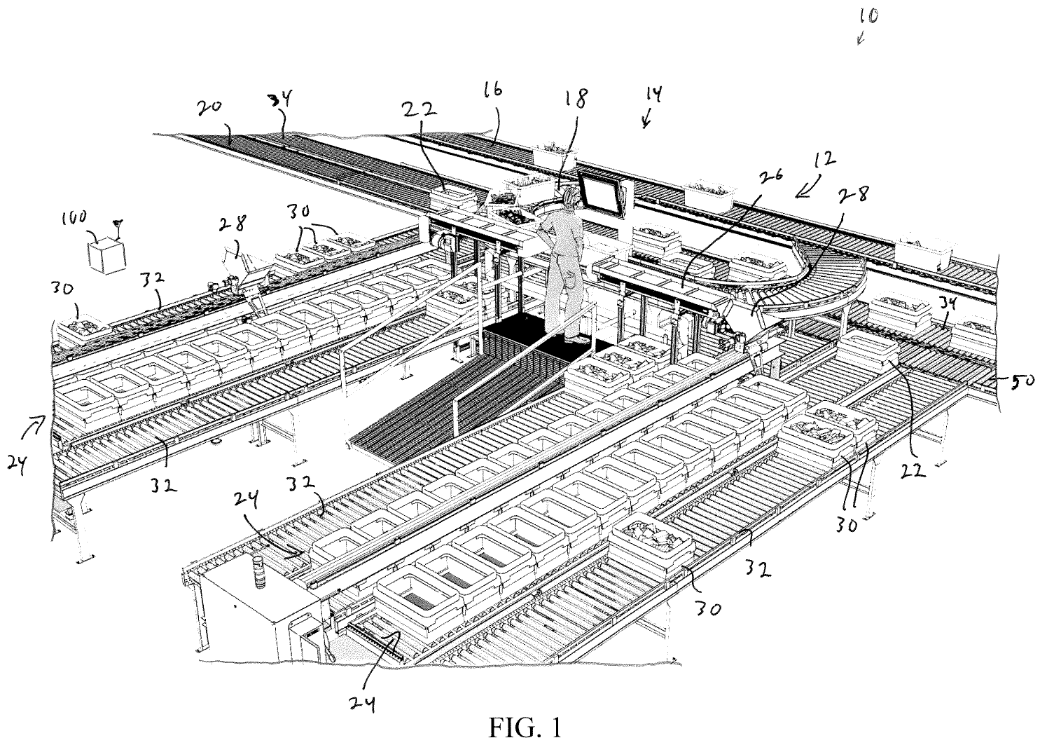

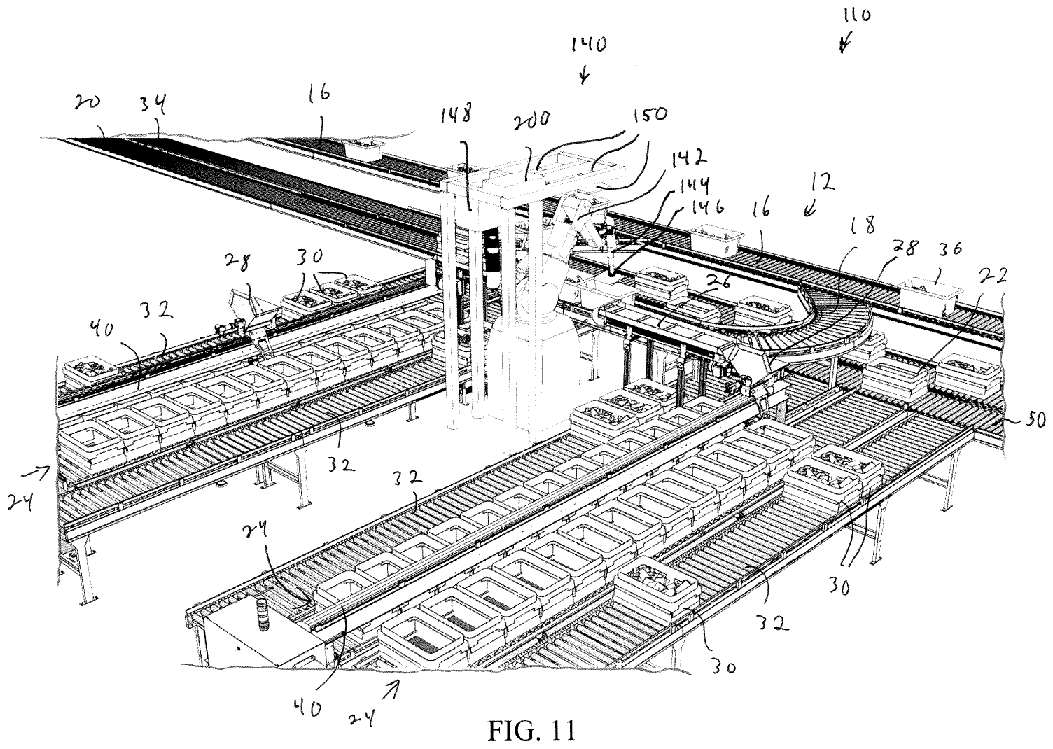

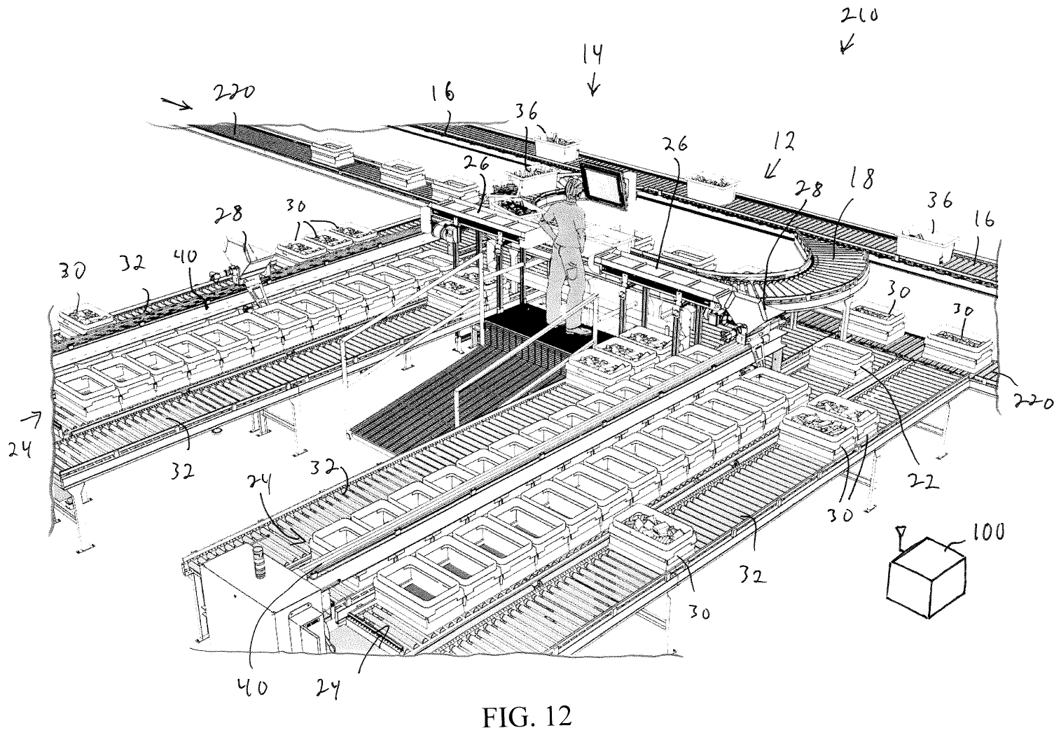

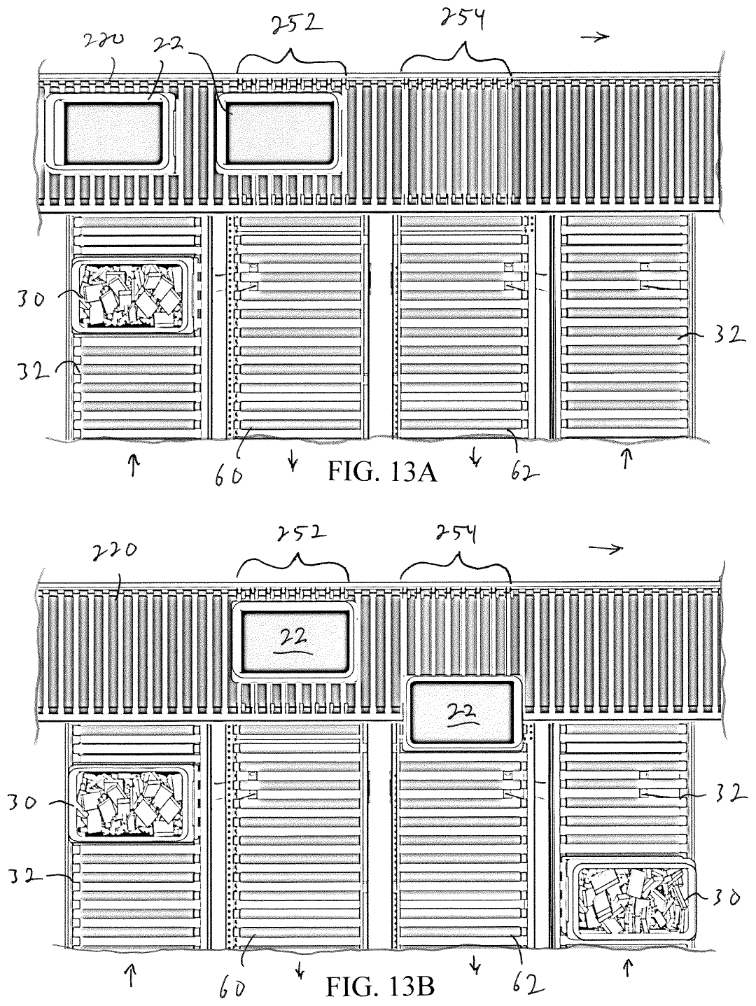

FIG. 1 for example shows an object processing system 10 that includes an infeed processing system 12 and a distribution system 14 that may include either a human personnel workstation (as shown in FIG. 1) or a programmable motion device workstation (as shown in FIG. 11). The infeed processing system 12 includes a source bin feed conveyor 16 that may feed multiple stations (as discussed below), and a station feed conveyor 18 that communicates with the distribution system 14. The object processing system 10 further includes an empty bin feed conveyor 20 for providing empty bins 22 to a plurality of collections of processing locations 24 that are gravity biased (or actively powered) to bias bins thereon away from the infeed processing system 12. The distribution system 14 includes one or more distribution conveyors 26 that each led to a reciprocating carriage 28, and each carriage may provide objects therein to any of a plurality of empty bins at the processing locations to thereby provide that the empty bins become processed bins 30 when processing for each respective bin is completed. Each completed processed bin 30 is then transferred to a processed bin holding conveyor 32 until the time is right to move the bin 30 onto a processed bin feed conveyor 34 by crossing over the empty bin feed conveyor 20. In the system of FIG. 1, the empty bin feed conveyor 20 becomes a common outfeed conveyor 50 at the discharge-side of the distribution system 14 by which both empty bins and processed bins are conveyed at some point in time. In accordance with other aspects, the empty bin feed conveyor may be positioned outside the processed bin feed conveyor, with the processed bin feed conveyor being the common outfeed conveyor (as discussed below with reference to FIG. 10). In accordance with further aspects, the empty bins and the processed bins may both be conveyed by a single conveyor as discussed below with reference to FIG. 12.

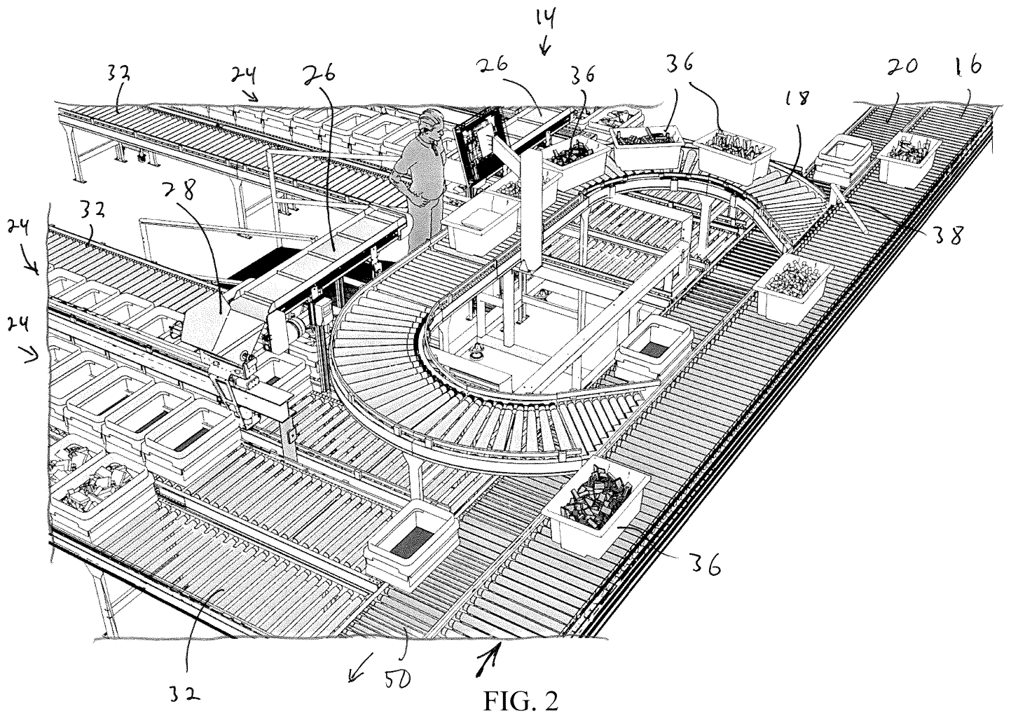

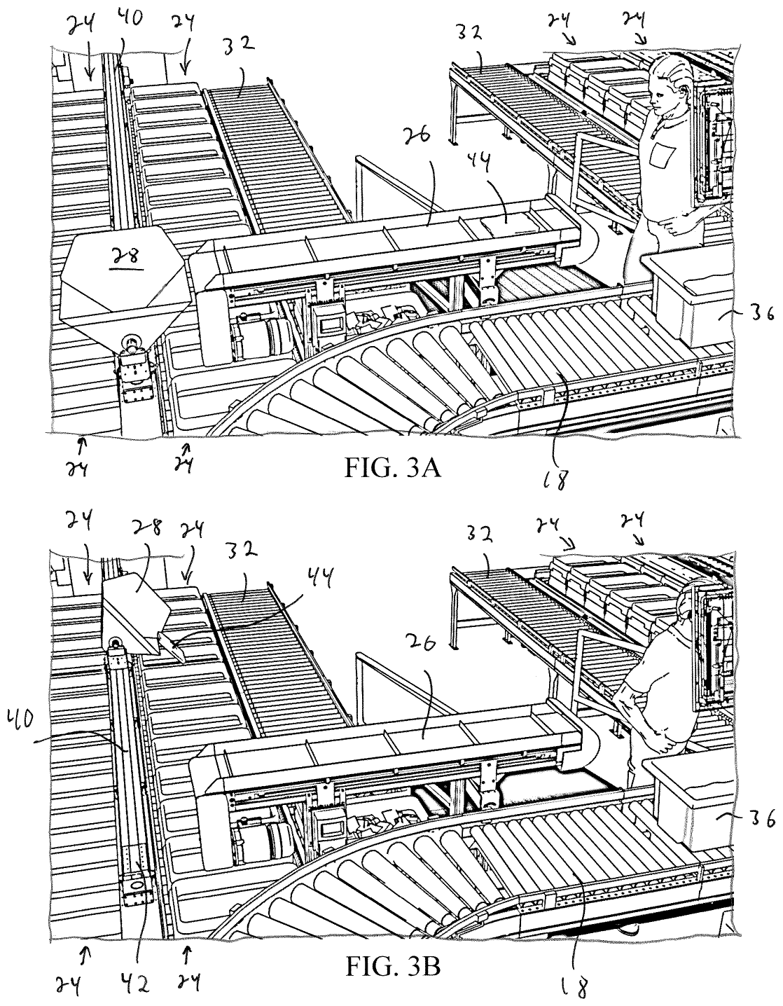

FIG. 2 shows an enlarged view of the distribution system 14 including the source bin feed conveyor 16 and the station feed conveyor 18, by which the distribution system 14 may access the objects to be processed in the source bins 36 when diverted by diverter 38 (shown in the diverting position) from the source bin feed conveyor 16. Diverter 38 pivots to permit source bins 36 to bypass the station feed conveyor, including those returning to the source bin feed conveyor 16 from the station feed conveyor 18. The distribution system constitutes any of human personnel (as shown in FIG. 2) or a programmable motion device (as shown in FIG. 11), and may be used to move objects (e.g., object 44) from the source bins 36 to a distribution conveyor 26 as further shown in FIGS. 3A and 3B. FIGS. 3A and 3B show an alternative perspective of the enlarged view of the distribution system 14 shown in FIG. 2. As shown in FIG. 3A, the station feed conveyor 18 presents source bins 36 where an object from the source bin 36, such as object 44, is placed on the distribution conveyor 26. The distribution conveyor 26 leads to a reciprocating carriage 28 that travels along a track 40. FIG. 3B shows the reciprocating carriage 28 of FIG. 3A, which in turn moves to and drops the object 44 into one of a plurality of processing locations 24. The carriage 28 can deposit an object to any one of the processing locations 24 by tilting in one of two tilting directions. The carriage 28 then returns to a start position 42 where it may receive another object from the distribution conveyor 26. Processed bin holding conveyor 32 receives and holds completed processed bins 30 as will be described in more detail below. Operation of all conveyors, perception systems and processing equipment in each of the systems disclosed herein may be performed by one or more computer processing systems (e.g., 100 shown in FIGS. 1 and/or 200 shown in FIG. 11).

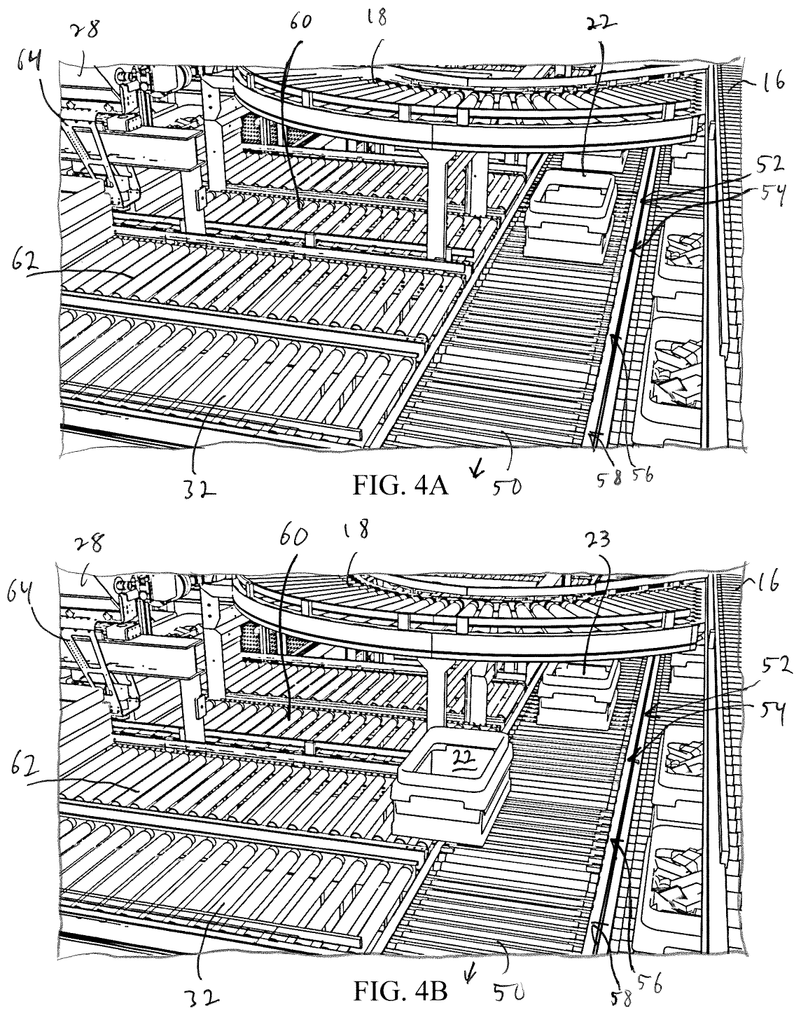

With reference to FIGS. 4A and 4B, the common outfeed conveyor 50 (which in the system of FIG. 1 is provided by the empty bin feed conveyor 20) includes bi-directional diverts (e.g., 52, 54, 56, 58) that may selectively move a bin thereon in a direction transverse to a direction of movement of the conveyor (e.g., by including sets of belts interleaved among rollers on elevatable mounts as shown). The diverts 54 and 56 selectively divert empty bins onto either of conveyors 60, 62 respectively for example, thereby providing new bins in each processing location 24 (discussed above). FIG. 4A shows an empty bin 22 approaching a divert 56, and FIG. 4B shows the bin 22 having been diverted onto the conveyor 62. The bi-directional divert 56 is shown in FIG. 4A with the divert belts not elevated (permitting movement along conveyor 50) and FIG. 4B shows the divert belts elevated to be above the adjacent rollers. The divert 54 may similarly be engaged to divert an empty bin (e.g., bin 23 show in FIG. 4B) onto the conveyor 60.

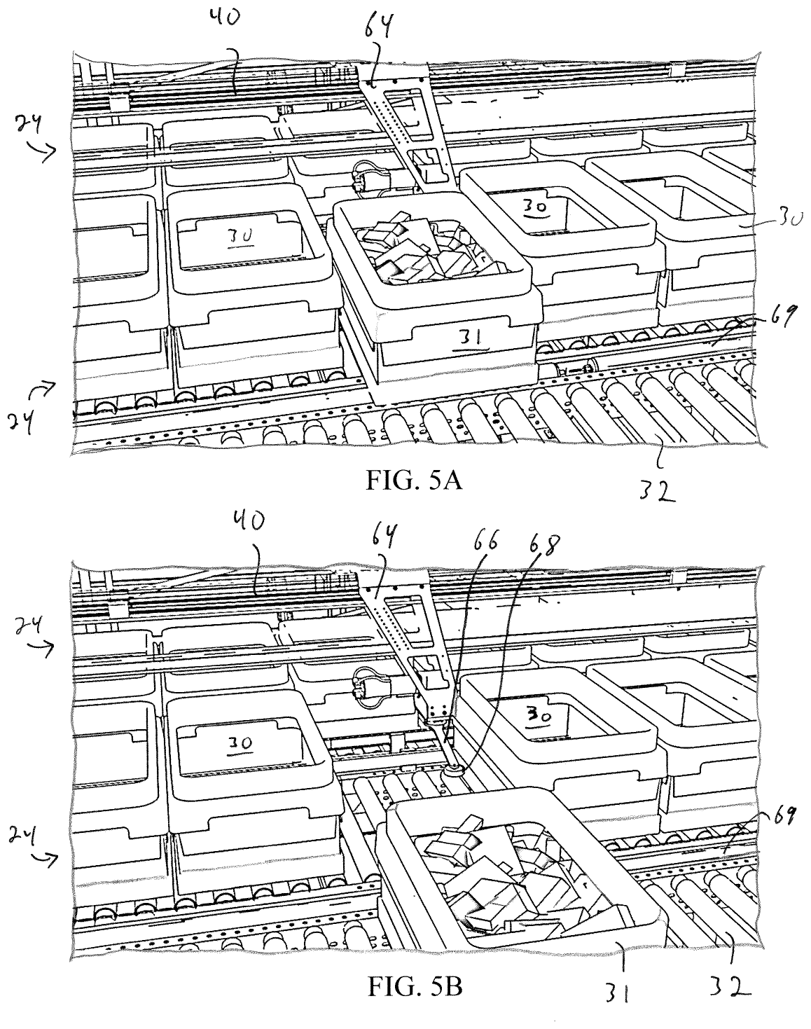

Objects are distributed and the bins are processed at the processing locations as discussed above, and as each individual processing bin becomes full, the bin is displaced onto a processed bin holding conveyor 32. FIGS. 5A and 5B show a completed processing bin 31 for example being engaged (FIG. 5A) and then discharged (FIG. 5B) from the processing location 24. In particular FIG. 5A shows the completed processing bin 31 (either full or finished being processed) being engaged by the bin discharge mechanism 64 that is attached to the carriage 28 (as shown in FIGS. 4A and 4B). The bin discharge mechanism 64 includes a pivoting arm 66 with a roller engaging wheel 68 that engages (FIG. 5A) and then pushed the bin 31 away from the processing location 24 over one or more rollers 69 onto the processed bin holding conveyor 32 (FIG. 5B). The processed holding conveyor 24 may hold each processed bin until a timing is appropriate for moving the bin onto the common outfeed conveyor 50, for opportune times when the common outfeed conveyor preceding the intersection is empty.

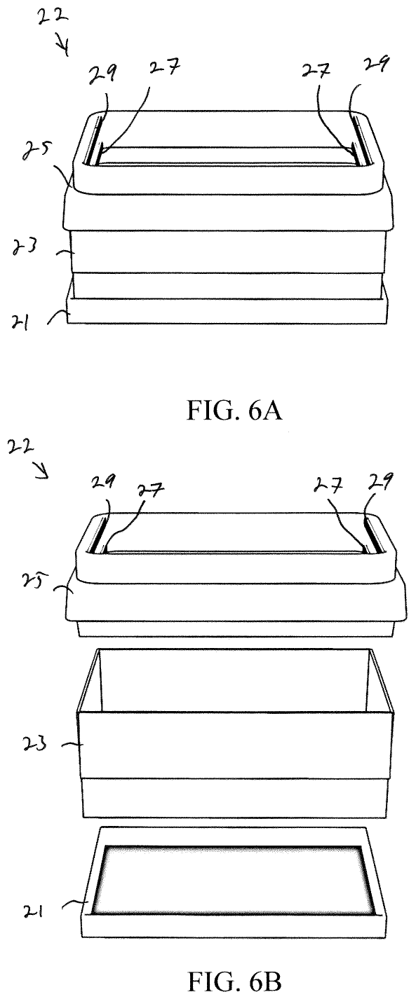

Each of the bins (e.g., 22) may be provided as a shipping box 23 on a tray 21 as shown in FIGS. 6A-6B. A box cover 25 may also be provided that includes a pair of box full photo detectors 27, as well as a pair of box over-full detectors 29. The detector pairs may be, for example, LED emitter-detector pairs mounted on the box cover 25. The use of the detectors 27, 29 in determining whether a box is full may be sufficient in certain applications, but applicant has discovered that further analyses may be used in further applications.

The system directly addresses concerns identified by the applicants including providing 1) less walking 2) less waiting 3) less mental fatigue, and 4) less manual manipulation of sorter destination and less manipulation of the outbound carton or bag. These primary goals are achieved by aggregating the outbound of the sorter and bringing the output to a central bagging/boxing location; thus decreasing walking. Because the aggregated output can be buffered and a queue added peaks and valleys of output can be level loaded for manual close out and thus less waiting during valleys occurs and less blocking back-ups during peaks occur. Many centralized processing (bagging/boxing) stations are required as compared to destinations of the sorter. As such the centralized locations can be robotically and ergonomically optimized. Additionally, once an automated take away system of the outbound destination of a sorter is implemented, many second order optimizations can be done. Dynamic allocation of destinations to sorter output chutes can occur. Dynamic allocation of chutes to destinations allows some popular destinations to receive more chutes and level load the output and prevent sorter re-circulation.

Labor to process the output (bagging or boxing) is somewhat proportional to the number of bags/boxes used, up to an ergonomic limit. Typically, the less bags/boxes being processed the less labor required. Usually, it behooves the system operator fill bags/boxes as much as possible without exceeding an ergonomic limit. Along these lines typically the largest bag/box which does not result in ergonomic problems results in the lowest cost operation. Under full bags/boxes results in shipping air from the sorting site which is costly. So, once a tote is considered full from under the sorter, a bag/box process that can correctly size the bag/box to just hold the contents of the tote is the most economical option. The proposed system can monitor actual the actual contents of and output container and advise a manual or robotic bagging/boxing operation which is the right size outbound bag/box. If the sorter of which the automated take away and bagging/boxing is being done is for sorting sealed packages being shipped from A to B; then more optimizations can be applied. The output of a package sorter used in a logistics operation often must meet truck times or plane times. An automated take away system can automatically discharge destinations from the sorter to meet their truck time or plane time.

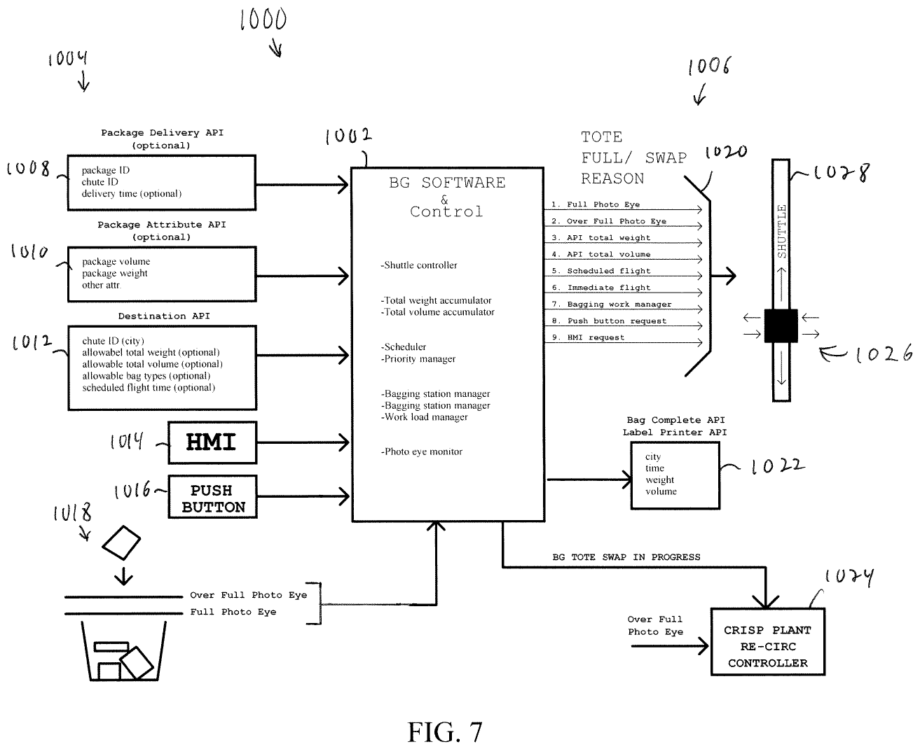

FIG. 7 for example, shows a functional diagram of a tote and bag fullness analysis system 1000 for use in accordance with an aspect of the invention (e.g., in any of the object processing systems discussed herein). The analysis system 1000 determines when a tote is complete enough to be traded for an empty tote, and includes a software and control system 1002 (e.g., that may reside in the one or more computer processing systems 100, 200). The system 1000 receives input parameters as shown at 1004, and provides completeness determinations as shown at 1006 based on any of a variety of reasons as discussed below. The input parameters include package delivery information shown at 1008, package attribute information shown at 1010, destination information shown at 10212, human machine interface information shown at 1014, push button information shown at 1016, and full and over-full detection information as shown at 1018.

The package (object) delivery information (e.g., provided via an application programming interface, API), includes package ID, chute ID and delivery time as shown at 1008. The package attribute information (e.g., provided via API) includes package volume, package weight, package size and other attributes as shown at 1010. The destination information (e.g., provided via API) includes chute ID (city, allowable total weight, allowable total volume, allowable bag types, and scheduled leaving times (e.g., flight times) as shown at 1012. The human machine interface may provide additional observable information regarding the package as shown at 1014, and the push button information may include pre-programmed select information that may be entered very quickly as shown at 1016. The full and over-full detection information as shown at 1018 may be provided by one or more sensor systems discussed above with reference to the detector pairs 27, 29 of FIGS. 6A and 6B.

The software and control system 1002 receives the above input information and processes the data to control the shuttle, monitor total weight accumulated, monitor total volume accumulated, monitor any changes in the schedule and/or priority, and monitor the full and over-full detection information. The control system 1002 also communicates with boxing and bagging station managers as well as work-load managers. The system, for example, may not simply rely on one or two points of information 1020 (e.g., a full or over-full sensor signal), but may consider total weight or total volume. At 1006 a tote full/swap assessment is made. If the total weight and/or total volume are far too low, the system will not consider the tote to be completed. On the other hand, if a scheduled leaving time (e.g., flight) or immediate leaving time is approaching, the system may consider the tote to be completed not-withstanding other data indicating otherwise. Further, the system may be immediately responsive to instructions from a boxing or bagging station manager, a push button request, and/or a human machine interface instruction to immediately consider the tote to be completed. When the control system 1002 considers a tote to be completed, a bag-complete label is printed as shown at 1022, and a new empty tote is requested in a tote swap as shown at 1024. The detector pairs on the new empty tote may be checked to ensure that the tote is empty. The completed tote is then discharged as shown at 1026 onto a conveyor through shuttle controller 1028 (e.g., a bin holding conveyor 32 as shown in FIG. 1).

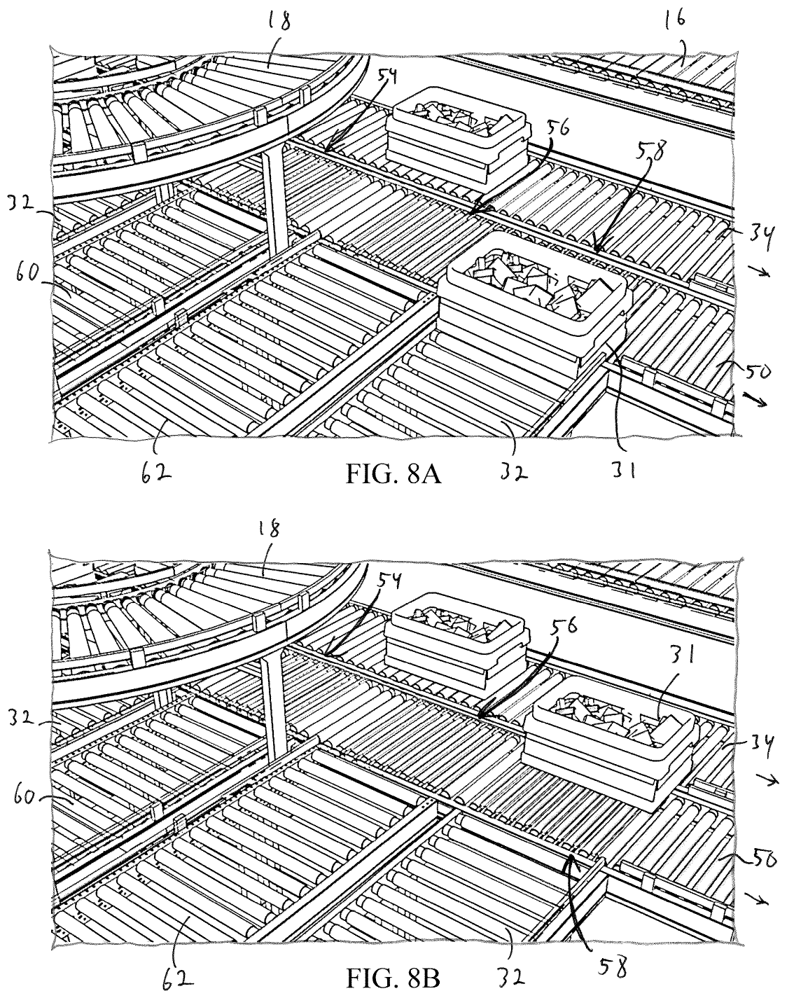

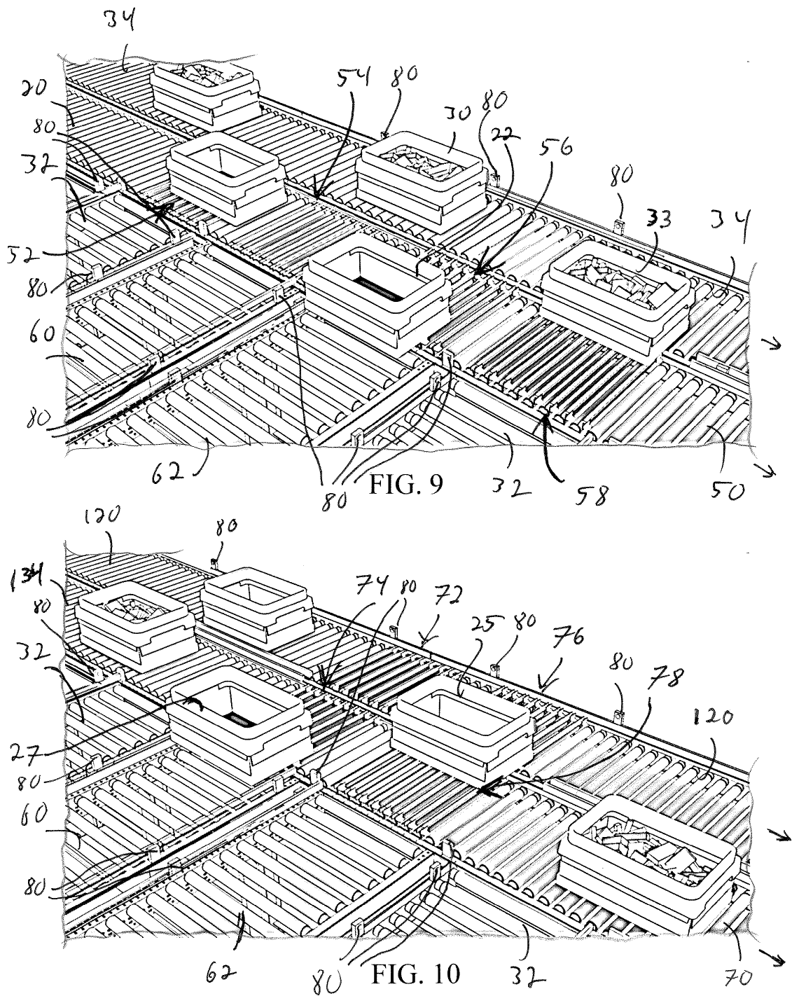

Once a bin is determined to be ready to be discharged (completed), the bin discharge mechanism moves the completed bin onto the holding conveyor 32 as discussed above with reference to FIGS. 5A and 5B. FIG. 8A shows the processed bin 31 being discharged from the holding conveyor 32 onto the divert 58 of the common outfeed conveyor 50, and FIG. 8B shows the processed bin 31 immediately thereafter being transferred by the divert 58 from the common outfeed conveyor 50 to the bin feed conveyor 34. The diverts 52 (shown in FIGS. 4A and 4B), 54, 56, 58 are all provided on the common outfeed conveyor 50, and with further reference to FIG. 9, diverts 54 and 56 divert empty bins (e.g., 22) onto the conveyors 60, 62 of the processing locations 24 (FIG. 1), and diverts 52, 58 divert processed bins (e.g., 33) from the holding conveyors 32 across the common out feed conveyor 50 to the processed bin conveyor 34. The processed bins therefore cross over the common outfeed conveyor 50 that originates as the empty bin feed conveyor 20. The diverts are therefore all positioned on the inner conveyor (the empty bin feed conveyor) and move both the empty bins onto the processing conveyors and move processed bins across the inner conveyor to the outer conveyor. As also shown in FIG. 9 (and FIG. 10), the object processing system 10 (as well as each of the object processing systems disclosed herein) includes perception systems 80 throughout the conveyors that provide information regarding positions of all bins (empty and processing and processed bins) on any and all of the conveyor systems discussed herein.

In accordance with further aspects, systems may be provided in which diverts are provided on both the inner and outer conveyors for moving bins from the outer conveyor, and across the inner conveyor to the processing conveyors. FIG. 10 for example, shows an object processing system similar to that of FIGS. 1-9 including the infeed processing system 12 and a distribution system 14 as discussed above that includes either a human personnel workstation (as shown in FIG. 1) or a programmable motion device workstation (as shown in FIG. 11). The infeed processing system 12 includes the source bin feed conveyor 16 and the station feed conveyor 18 that communicates with the distribution system 14. The object processing system 10 further includes the empty bin feed conveyor 20 for providing empty bins to the plurality of collections of processing locations that are gravity biased (or actively powered) to bias bins thereon away from the infeed processing system.

Similarly, as discussed above the distribution system 14 includes one or more distribution conveyors 26 that each led to a reciprocating carriage 28, and each carriage provides objects therein to any of a plurality of empty bins at the processing locations to thereby provide that the empty bins become processed bins when processing for each respective bin is completed. Each completed processed bin is then transferred to a processed bin holding conveyor 32 until the time is right to move the bin onto a processed bin feed conveyor. In the system of FIG. 10, the empty bin feed conveyor 120 is positioned outside the processed bin feed conveyor 134, with the processed bin feed conveyor being the common outfeed conveyor 70.

Again, any of human personnel (as shown in FIG. 2) or a programmable motion device (as shown in FIG. 11) may be used to move objects from the source bins to one of one or two distribution conveyors, and each distribution conveyor leads to the reciprocating carriage that travels along the track 40 (as discussed above and shown in FIG. 3A), which in turn moves to and drops the object into one of a plurality of processing locations 24 (as discussed above and shown in FIG. 3B). The carriage then returns to a start position, where it may receive another object from the distribution conveyor. Again, operation of all conveyors, perception systems and processing equipment in each of the systems disclosed herein may be performed by one or more computer processing systems (e.g., 100 shown in FIGS. 1 and/or 200 shown in FIG. 11).

In the system of FIG. 10 the outer conveyor 120 is the empty bin infeed conveyor and the inner conveyor 134 is the processed bin feed conveyor. The outer conveyor 120 includes two bi-directional diverts 72, 76 and the inner conveyor includes two bi-directional diverts 74, 78 at each processing location. The diverts 70, 72 are used to selectively divert an empty bin from the empty bin feed conveyor 120 first to the processed bin feed conveyor 134 and then to the processing conveyor 60. Similarly, the diverts 76, 78 may be used to selectively divert an empty bin from the empty bin feed conveyor 120 first to the processed bin feed conveyor 134 and then to the processing conveyor 62.

The inner conveyor 134 serves as the common outfeed conveyor 70 as both the processed bins move along the conveyor 70 and the empty bins cross the conveyor 70. The empty bins therefore cross over the common outfeed conveyor 70 that originates as the processed bin feed conveyor 20. The diverts are therefore positioned on the outer conveyor (the empty bin feed conveyor) the inner conveyor (the processed bin feed conveyor) along which the processed bins move and across which the empty bins are transferred onto the processing conveyors of each processing location. Each of the diverts therefore only act on empty bins, with the processed bins simply being transferred from the processed bin holding conveyors to the processed bin feed conveyor.

As noted above, any of the object processing systems discussed herein may include a distribution system with any of a human personnel workstation or a programmable motion device such an articulated arm robotic system. FIG. 11 for example shows an object processing system 110 that includes a distribution system 140 with a programmable motion device (e.g., an articulated arm) 142 with an end-effector 144 having a vacuum cup 146 and one or more perception systems 150. The vacuum cup 146 is attached via a hose to a vacuum source 148. The device 142 is used to move objects from source bins to a distribution conveyor that leads to a reciprocating conveyor as discussed above. The system 110 further includes the infeed processing system 12 that includes the source bin feed conveyor 16 and the station feed conveyor 18 that communicates with the distribution system 140. The object processing system 110 further include an empty bin feed conveyor 20 for providing empty bins 22 to a plurality of collections of processing locations 24 that are gravity biased (or actively powered) to bias bins thereon away from the infeed processing system 12. The distribution system 140 includes one or more distribution conveyors 26 that each led to a reciprocating carriage 28, and each carriage may provide objects therein to any of a plurality of empty bins at the processing locations 24 to thereby provide that the empty bins become processed bins 30 when processing for each respective bin is completed.

Each completed processed bin 30 is then transferred to a processed bin holding conveyor 32 until the time is right to move the bin 30 onto a processed bin feed conveyor 34 by crossing over the empty bin feed conveyor 20 as discussed above. In the system of FIG. 11, the empty bin feed conveyor 20 is a common outfeed conveyor 50 by which both empty bins and processed bins are conveyed at some point in time. In accordance with other aspects in systems that include a programmable motion device, the empty bin feed conveyor may be positioned outside the processed bin feed conveyor, with the processed bin feed conveyor being the common outfeed conveyor (as discussed above with reference to FIG. 10). In accordance with further aspects in systems that include a programmable motion device, the empty bins and the processed bins may both be conveyed by a single conveyor as discussed below with reference to FIG. 12.

Each distribution conveyor 26 leads to a reciprocating carriage 28 that travels along a track 40 (as discussed above with reference to FIG. 3A), which in turn moves to and drops the object into one of a plurality of processing locations 24 (as discussed above with reference to FIG. 3B). The carriage 28 then returns to a start position where it may receive another object from the distribution conveyor 26. Operation of all conveyors, perception systems and processing equipment in each of the systems disclosed herein may be performed by one or more computer processing systems (e.g., 200 as shown in FIG. 11).

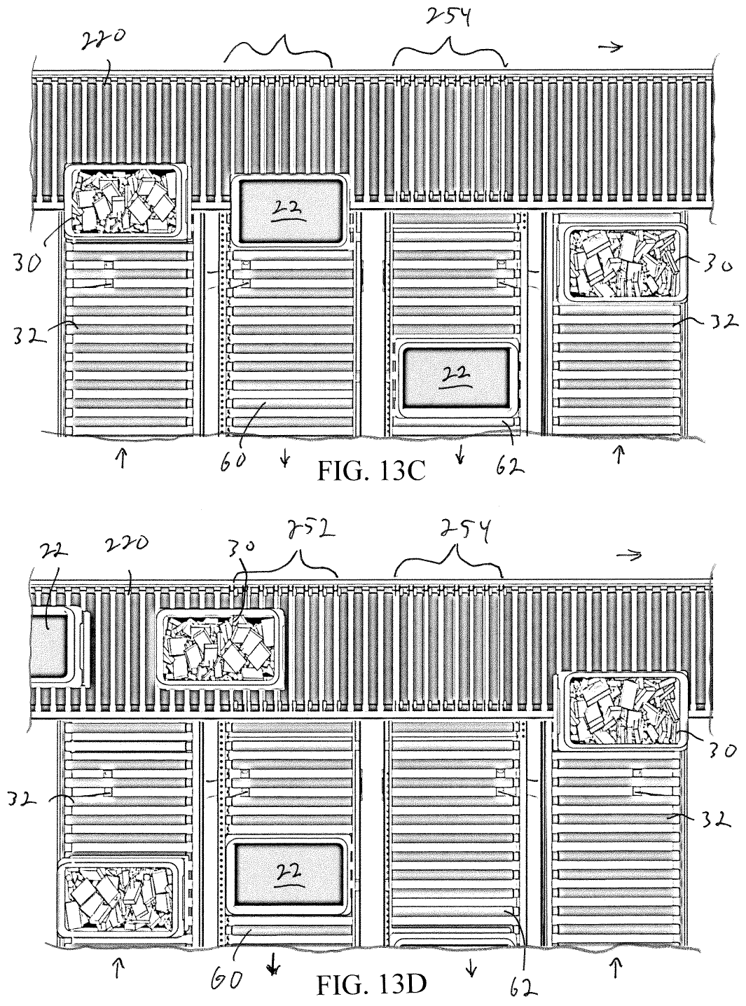

In the system shown in FIG. 9, the diverts are all positioned on the inner conveyor (the empty bin feed conveyor) and move both the empty bins onto the processing conveyors and move processed bins across the inner conveyor to the outer conveyor as discussed above with reference to FIGS. 1-9. In accordance with further aspects, systems including programmable motion devices may be provided in which diverts are provided on both the inner and outer conveyors for moving bins from the outer conveyor, and across the inner conveyor to the processing conveyors as discussed above with reference to FIG. 10. In accordance with still further aspects, system including programmable motion devices may be provided in which a single conveyor is provided as both the empty bin infeed conveyor and the processed bin outfeed conveyor (a common outfeed conveyor) as discussed below with reference to FIGS. 12-13D.

FIG. 12 shows an object processing system 210 that includes the infeed processing system 12 and the distribution system 14 that may include either a human personnel workstation (as shown in FIG. 1) or a programmable motion device workstation (as shown in FIG. 11). The infeed processing system 12 includes the source bin feed conveyor 16 and the station feed conveyor 18 that communicates with the distribution system 14. The object processing system 210 further include an empty bin feed conveyor 220 for providing empty bins 22 to the plurality of collections of processing locations 24 that are gravity biased (or actively powered) to bias bins thereon away from the infeed processing system 12. The distribution system 14 includes one or more distribution conveyors 26 that each lead to a reciprocating carriage 28, and each carriage provides objects therein to any of a plurality of empty bins at the processing locations to thereby provide that the empty bins become processed bins 30 when processing for each respective bin is completed. Each completed processed bin 30 is then transferred to a processed bin holding conveyor 32 until the time is right to move the bin 30 onto the empty bin feed conveyor 220 that serves as the common outfeed conveyor.

Any of human personnel (as shown in FIG. 2) or a programmable motion device (as shown in FIG. 11) may be used to move objects (e.g., object 44) from the source bins 36 to a distribution conveyor 26 as discussed above with reference to FIGS. 3A and 3B. Each distribution conveyor 26 leads to a reciprocating carriage 28 that travels along a track 40, which in turn moves to and drops the object into one of a plurality of processing locations 24. The carriage 28 then returns to a start position, where it may receive another object from the distribution conveyor 26. Operation of all conveyors, perception systems and processing equipment in each of the systems disclosed herein may be performed by one or more computer processing systems (e.g., 100 shown in FIG. 12).

With reference to FIGS. 13A-13D, the common outfeed conveyor 220 (which in the system of FIG. 12 is provided by the empty bin feed conveyor) includes bi-directional diverts (e.g., 252, 254) that may selectively move a bin thereon in a direction transverse to a direction of movement of the conveyor (e.g., by including sets of belts interleaved among rollers on elevatable mounts as shown and discussed above). The divert 252 selectively diverts empty bins onto the processing conveyor 60, and the divert 254 selectively diverts empty bins onto the processing conveyor 62, thereby providing new bins in each processing location 24 (discussed above). FIG. 13A shows two empty bins 22 approaching processing conveyors 60, 62 respectively, and FIG. 13B shows one empty bin 22 being diverted onto the processing conveyor 62. FIG. 13C shows the other empty bin 22 being diverted onto processing conveyor 60.

Objects are distributed and the bins are processed at the processing locations as discussed above, and as each individual processing bin becomes full, the bin is displaced onto the common outfeed conveyor 220. The completed processing bin (either full or finished being processed) is engaged by the bin discharge mechanism that is attached to the carriage 28 (as discussed above with reference to FIGS. 4A and 4B). The bin discharge mechanism includes a pivoting arm with a roller engaging wheel that engages and then pushes the bin away from the processing location over one or more rollers onto the processed bin holding conveyor as discussed above. The processed holding conveyor 32 may hold each processed bin until a timing is appropriate for moving the bin onto the common outfeed conveyor 220.

FIG. 13A also shows a processed bin 30 waiting to enter the conveyor 220 and FIG. 13B shows another processed bin 30 approaching conveyor 220. FIG. 13C shows the first processed bin 30 being transferred onto the conveyor 220, and FIG. 13D shows the second processed bin 30 being transferred onto the conveyor 220. The system therefore uses two diverts per set of two processing locations.

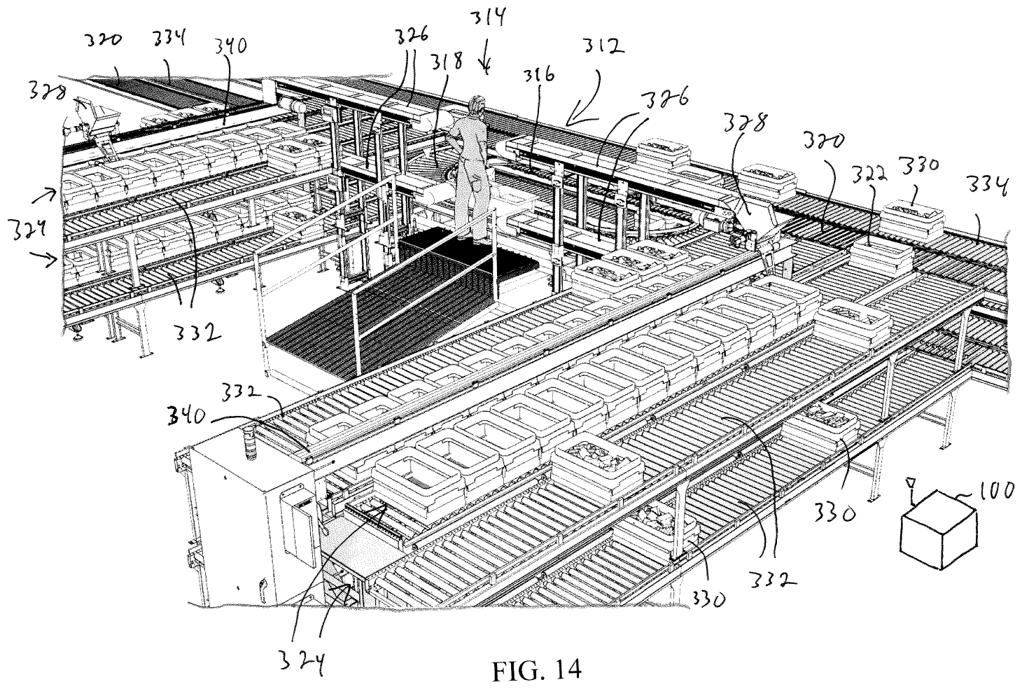

Object processing systems in accordance with further aspects of the present invention may include stack processing system as disclosed for example in FIG. 14. FIG. 14 shows an object processing system 310 that includes a distribution system 314 with any of a human personnel workstation (as shown) or a programmable motion device (e.g., as discussed above with reference to FIG. 11) at which objects are moved from source bins to a distribution conveyor 326 (of two stacks of distribution conveyors 326) that leads to a reciprocating carriage 328 (of two stacks of reciprocating carriages 328) as discussed above. The system 310 further includes the infeed processing system 312 that includes the source bin feed conveyor 316 and the station feed conveyor 318 (which may be elevated at the workstation or programmable motion device) that communicates with the distribution system 314. The object processing system 310 further include a pair of stacked empty bin feed conveyors 320 for providing empty bins 322 to a plurality of stacked collections of processing locations 324 that are gravity biased (or actively powered) to bias bins thereon away from the infeed processing system 312. The distribution system 314 includes one or more stacked distribution conveyors 326 that each lead to a reciprocating carriage 328, and each carriage may provide objects therein to any of a plurality of empty bins at the stacked processing locations 324 to thereby provide that the empty bins become processed bins 330 when processing for each respective bin is completed.

Each completed processed bin 330 is then transferred to one of a stacked processed bin holding conveyor 332 until the time is right to move the bin 330 onto one of a stacked processed bin feed conveyor 334, e.g., by crossing over the empty bin feed conveyor 320 as discussed above. In the system of FIG. 14 as shown, the empty bin feed conveyors 320 are the common outfeed conveyors (two stacked) by which both empty bins and processed bins are conveyed at some point in time. In accordance with other aspects, the stacked empty bin feed conveyors may be positioned outside the stacked processed bin feed conveyors, with the processed bin feed conveyors being the common outfeed conveyors (as discussed above with reference to FIGS. 8A and 8B). In accordance with further aspects, the empty bins and the processed bins may both be conveyed by a pair of stacked single conveyors as discussed above with reference to FIG. 12.

Similarly, each stacked distribution conveyor 326 leads to a stacked system with each layer including a reciprocating carriage 328 that travels along a track 340 (as discussed above with reference to FIG. 3A), which in turn moves to and drops the object into one of a plurality of stacked processing locations 324 (as discussed above with reference to FIG. 3B). The carriage 328 then returns to a start position where it may receive another object from the distribution conveyor 326. Operation of all conveyors, perception systems and processing equipment in each of the systems disclosed herein may be performed by one or more computer processing systems (e.g., 100 as shown in FIG. 14).

In the system shown in FIG. 14, the diverts are all positioned on the stacked inner conveyors (the empty bin feed conveyors) and move both the empty bins onto the stacked processing conveyors and move processed bins across the stacked inner conveyors to the stacked outer conveyors as discussed above with reference to FIGS. 1-9. In accordance with further aspects, systems may be provided in which diverts are provided on both the stacked inner and outer conveyors for moving bins from the stacked outer conveyors, and across the stacked inner conveyors to the stacked processing conveyors as discussed above with reference to FIG. 10. In accordance with still further aspects, system may be provided in which stacked single conveyors are provided as both the empty bin infeed conveyor and the processed bin outfeed conveyor (a common outfeed conveyor) as discussed below with reference to FIGS. 12-13D. In accordance with still further aspects, object processing systems may be provided in which stacked processing systems as employed with each layer of the stack including the same arrangement of infeed and outfeed conveyances and diverts (as discussed above) or with each layer of the stack including different arrangements of infeed and outfeed conveyances and diverts. Operation of all conveyors, perception systems and processing equipment in each of the systems disclosed herein may be performed by one or more computer processing systems (e.g., 100 shown in FIG. 14).

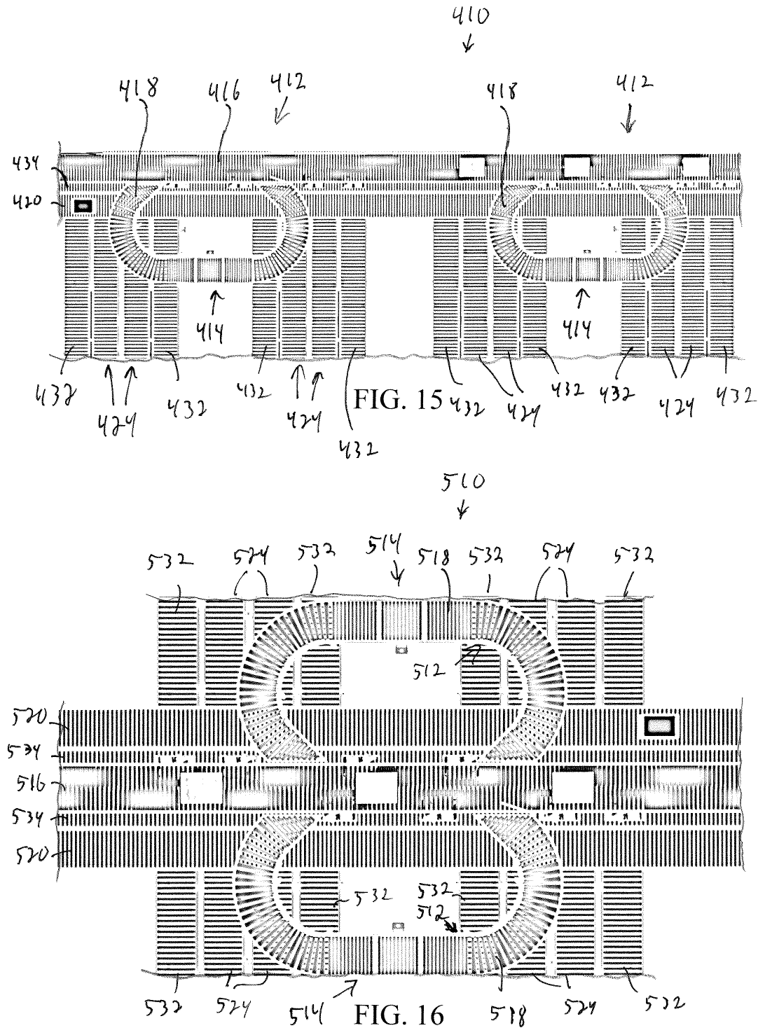

In accordance with further aspects, object processing systems in accordance with aspects of the invention may be provided that include multiple sets of work-stations next to each other, with associated pairs of processing locations. For example, FIG. 15 shows an object processing system 410 that includes plural adjacent stations with infeed processing systems 412 and distribution systems 414 on the same side of a source bin feed conveyor 416, where each infeed processing system includes a station feed conveyor 418 and plural processing locations 424 and plural processed bin holding conveyors 432, all of which operate as discussed above using any of the combinations of distribution systems (e.g., human personnel or programmable motion device) and any of the common outfeed conveyors discussed above). Such a system 410 may be used for example in applications where the source bin feed conveyor 416, empty bin feed conveyor 420 and processed bin feed conveyor 434 run along a wall of a facility.

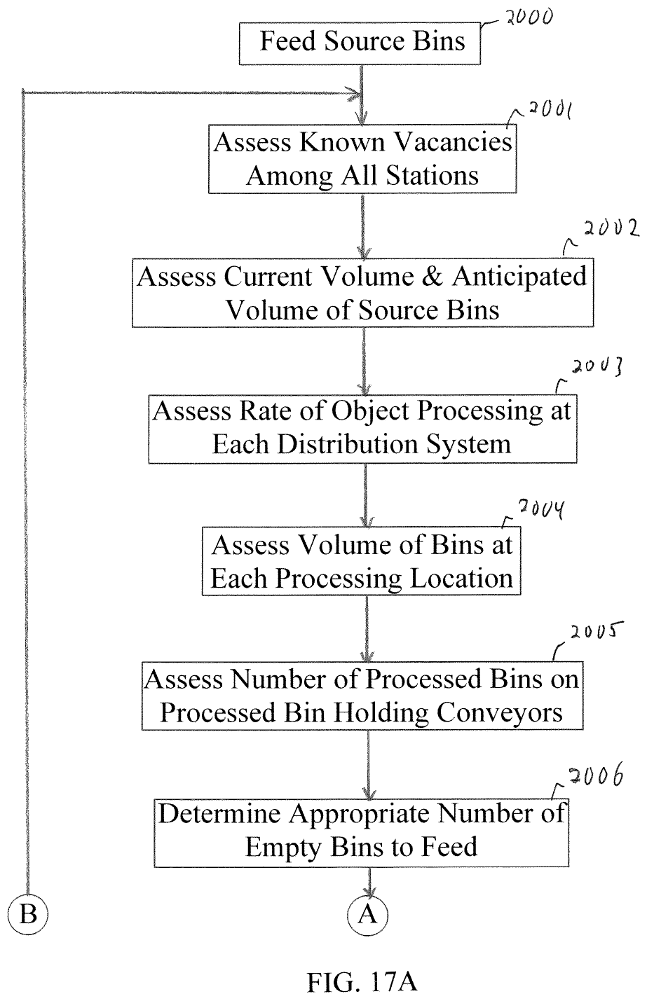

In accordance with further aspects, object processing systems in accordance with aspects of the invention may be provided that include multiple sets of work-stations across from each other, with associated pairs of processing locations. For example, FIG. 16 shows an object processing system 510 that includes plural opposing stations with infeed processing systems 512 and distribution systems 514 on the same side of a source bin feed conveyor 516, where each infeed processing system includes a station feed conveyor 518 and plural processing locations 524 and plural processed bin holding conveyors 532, all of which operate as discussed above using any of the combinations of distribution systems (e.g., human personnel or programmable motion device) and any of the common outfeed conveyors discussed above). Such a system 510 may be used for example in applications where the source bin feed conveyor 516, empty bin feed conveyors 520 and processed bin feed conveyors 534 run through a center of a facility.

In addition to providing a plurality of work-stations (e.g., on one or both sides of a source bin feed conveyor), object processing systems in accordance with various aspects may further includes that the source bins may run in a continuous loop returning to a point of entry in the system. Further, the empty bins may also run in a continuous loop returning to a point of entry on the system (e.g., where the processed bin conveyor is the common outfeed conveyor). In applications where any unused empty bins are combined with the processed bins, the empty bins may be separated and returned to a point of entry of the empty bins to the system. Although in some applications it may be desired to have all empty bins used in each pass, in other applications it may be more efficient to provide the flexibility of having additional empty bins available during processing.

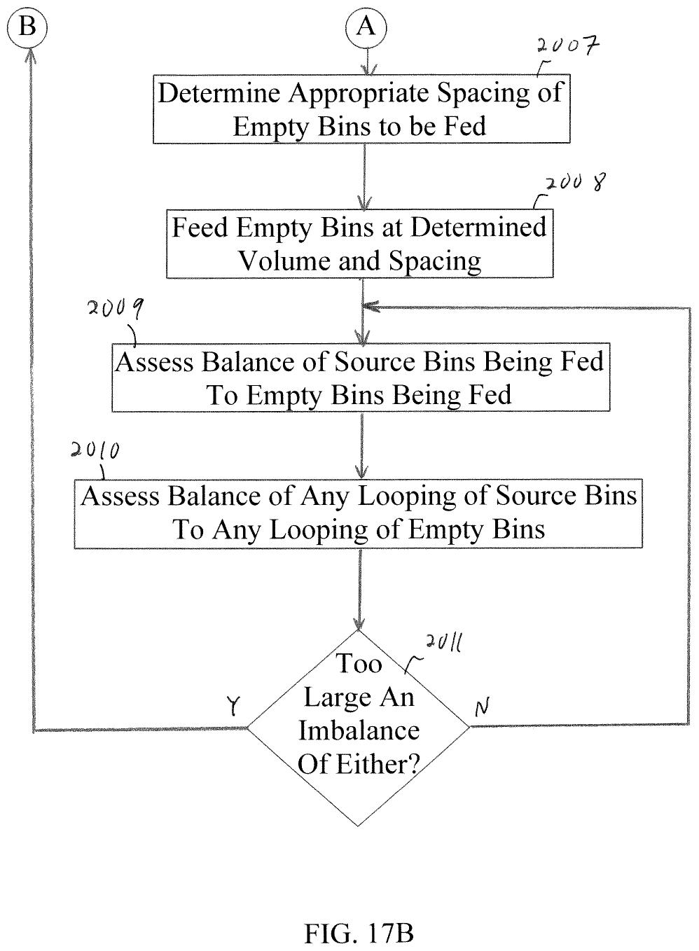

FIGS. 17A and 17B show illustrative process flow steps in a processing system in accordance with an aspect of the invention (for example, as provided by the one or more computer processing systems 100, 200 discussed herein). In particular and with reference to FIG. 17A, the system may begin by feeding source bins into the system (step 2000). The system will then assess known vacancies among all stations (step 2001), which at startup will be all stations. In accordance with certain aspects, the system may begin by populating all stations with empties prior to feeding source bins into the system. The system may then assess the current volume of source bins being fed as well as the anticipated volume of source bins to be fed over a near term period of time, such as 30 to 90 minutes (step 2002). The system may also assess the rate of object processing at each station (step 2003) in order to best determine where and when to distribute empty bins to each station. The system may then assess the volume of bins being processed at each processing location (step 2004), which may be the maximum number of bins that may be provided at each processing location, or may be less depending on whether any station is awaiting new empty bins. The system may then assess the number of processed bins on the processed bin holding conveyors (step 2005). These are bins that are ready to be discharged into the common outfeed conveyor but are awaiting being moved so as to maximize efficiency in moving one or more empty bins first if empty bins are needed in the system downstream of the waiting bins. Based on all of the above, the system may then determine the appropriate number of bins to feed into the system (step 2006).

With further reference to FIG. 17B, the system may then determine the appropriate spacing of empty bins to be fed in the system (step 2007), and then feed the empty bins at the determined volume and spacing (step 2008). By adjusting the spacing, the system permits processed bins to be interleaved between the empty bins on the common outfeed conveyor as discussed above. Introducing empty bins without such spacing may slow down the system as processed bins may be waiting to be moved. As any and all empty bins may later become processed bins, and the volume of processed bins is at least proportional to the number of source bins, the system may assess a relative balance of source bins being fed to empty bins being fed into the system (step 2009). Further, in applications in which the source bins loop back for recirculation and the empty bins loop back for recirculation as discussed above, the system may assess a relative balance of any looping of source bins to any looping of empty bins (step 2010). The system may then determine whether either imbalance is too large (step 10111), and if not, return to the steps of assessing the balance (step 2009), and if so, return to the steps of assessing vacancies, volume, processing rates and counts (step 2001).

System in accordance with various aspects of the present invention provide, in certain applications, back discharging systems with smaller and simpler cell footprint, easier personnel access and jam clearing (no crossing over conveyors), reduced deployment effort, and significant cost savings. For example, providing messages outside of the system may require multiple climbs over conveyors to assess a situation, check a message, clear a jam, and return to a distribution work station. Additionally, providing empty and processed (full) bins on a common conveyor (at least in part) reduces hardware, and with the added buffer capacity of the process bin holding conveyors (e.g., four per station) provides significant buffer capacity for sites with waving or highly variable volume. Further, empty bins may be replenished during lower volume processing times, maintaining throughput during high volume object processing.

Those skilled in the art will appreciate that numerous modifications and variations may be made to the above disclosed embodiments without departing from the spirit and scope of the invention.

What is claimed is:

1. An object processing system comprising:
an infeed processing system including a source bin feed conveyor for providing source bins;
a distribution system for receiving the source bins and for receiving a plurality of empty bins, and for providing objects from the source bins to a collection of processing locations, each processing location including an empty bin of the plurality of empty bins thereby providing the previously empty bins as processed bins when completed; and
an outfeed processing system for moving the processed bins away from the collection of processing locations, wherein the empty bins and the processed bins are each positioned at some point in their respective output paths on a common out-feed conveyor.

2. The object processing system as claimed in claim 1, wherein the common out-feed conveyor is a processed bin feed conveyor, and wherein the empty bins cross between processed bins on the processed bin feed conveyor.

3. The object processing system as claimed in claim 1, wherein the common out-feed conveyor is an empty bin feed conveyor, and wherein the processed bins cross between empty bins on the empty bin feed conveyor.

4. The object processing system as claimed in claim 1, wherein the empty bins and the processed bins are both provided comingled on the common out-feed conveyor.

5. The object processing system as claimed in claim 1, wherein the outfeed processing system further includes a processed bin holding conveyor onto which completed bins are moved from the distribution system, said processed bin holding conveyor being in communication with the common out-feed conveyor.

6. The object processing system as claimed in claim 5, wherein the distribution system includes a distribution conveyor on which the empty bins are provided for processing, said distribution conveyor being biased to urge the empty bins away from the infeed processing system.

7. The object processing system as claimed in claim 6, wherein when a removed processed bin is moved from the distribution conveyor to the processed bin holding conveyor, remaining bins remaining on the distribution conveyor are moved to close a space left by the removed processed bin.

8. The object processing system as claimed in claim 5, wherein the system further includes a processing system for controlling movement at least some of the empty bins or the processed bins on the common out-feed conveyor such that processed bins are held at the processed bin holding conveyor until the common out-feed conveyor is ready to receive them.

9. The object processing system as claimed in claim 1, wherein the distribution system includes a human personnel workstation proximate the source bin feed conveyor and a distribution conveyor of the distribution system.

10. The object processing system as claimed in claim 1, wherein the distribution system includes a programmable motion device proximate the source bin feed conveyor and a distribution conveyor of the distribution system, said programmable motion device for providing objects from the source bins to the distribution conveyor.

11. The object processing system as claimed in claim 1, wherein the distribution system further includes a reciprocating carriage that receives objects from the infeed processing system.

12. The object processing system as claimed in claim 1, wherein the object processing system further includes a plurality of collections of processing locations and outfeed processing systems, wherein the plurality of sets of processing locations are each in communication with the distribution system.

13. The object processing system as claimed in claim 12, wherein the plurality of collections of processing locations are provided on either side of the distribution system.

14. The object processing system as claimed in claim 12, wherein the plurality of collections of processing locations are stacked one upon the other.

15. The object processing system as claimed in claim 1, wherein the object processing system further includes a plurality of sets of distribution systems, collections of processing locations and outfeed processing systems.

16. The object processing system as claimed in claim 15, wherein the plurality of sets of distribution systems, collections of processing locations and outfeed processing systems are provided on the same side of the source bin processing conveyor.

17. The object processing system as claimed in claim 15, wherein the plurality of sets of distribution systems, collections of processing locations and outfeed processing systems are provided on opposite sides of the source bin processing conveyor.

18. An object processing system comprising:
a distribution system for receiving a plurality of source bins and for receiving a plurality of empty bins, and for providing objects from the source bins to a plurality of processing locations that each include an empty bin of the plurality of empty bins thereby providing the previously empty bins as processed bins when completed, wherein the plurality of processing locations is provided as at least two sets of collections of processing locations that are positioned on either side of the distribution system; and
an outfeed processing system for moving the processed bins away from the plurality of processing locations, wherein the empty bins and the processed bins are each positioned at some point in their respective output paths on a common out-feed conveyor.

19. The object processing system as claimed in claim 18, wherein the common out-feed conveyor is a processed bin feed conveyor, and wherein the empty bins cross between processed bins on the processed bin feed conveyor.

20. The object processing system as claimed in claim 18, wherein the common out-feed conveyor is an empty bin feed conveyor, and wherein the processed bins cross between empty bins on the empty bin feed conveyor.

21. The object processing system as claimed in claim 18, wherein the empty bins and the processed bins are both provided comingled on the common out-feed conveyor.

22. The object processing system as claimed in claim 18, wherein the outfeed processing system further includes a processed bin holding conveyor onto which completed bins are moved from the distribution system, said processed bin holding conveyor being in communication with the common out-feed conveyor.

23. The object processing system as claimed in claim 22, wherein the distribution system includes a distribution conveyor on which the empty bins are provided for processing, said distribution conveyor being biased to urge the empty bins away from the infeed processing system.

24. The object processing system as claimed in claim 23, wherein when a removed processed bin is moved from the distribution conveyor to the processed bin holding conveyor, remaining bins remaining on the distribution conveyor are moved to close a space left by the removed processed bin.

25. The object processing system as claimed in claim 22, wherein the system further includes a processing system for controlling movement at least some of the empty bins or the processed bins on the common out-feed conveyor such that processed bins are held at the processed bin holding conveyor until the common out-feed conveyor is ready to receive them.

26. The object processing system as claimed in claim 18, wherein the distribution system includes a human personnel workstation proximate the source bin feed conveyor and a distribution conveyor of the distribution system.

27. The object processing system as claimed in claim 18, wherein the distribution system includes a programmable motion device proximate the source bin feed conveyor and a distribution conveyor of the distribution system, said programmable motion device for providing objects from the source bins to the distribution conveyor.

28. The object processing system as claimed in claim 18, wherein the distribution system further includes a reciprocating carriage that receives objects from the infeed processing system.

29. The object processing system as claimed in claim 18, wherein the object processing system further includes a plurality of collections of processing locations and outfeed processing systems, wherein the plurality of sets of processing locations are each in communication with the distribution system.

30. The object processing system as claimed in claim 29, wherein the plurality of collections of processing locations are provided on either side of the distribution system.

31. The object processing system as claimed in claim 29, wherein the plurality of collections of processing locations are stacked one upon the other.

32. The object processing system as claimed in claim 18, wherein the object processing system further includes a plurality of sets of distribution systems, collections of processing locations and outfeed processing systems.

33. The object processing system as claimed in claim 32, wherein the plurality of sets of distribution systems, collections of processing locations and outfeed processing systems are provided on the same side of the source bin processing conveyor.

34. The object processing system as claimed in claim 32, wherein the plurality of sets of distribution systems, collections of processing locations and outfeed processing systems are provided on opposite sides of the source bin processing conveyor.

35. A method of processing objects comprising:
receiving a plurality of source bins at a distribution system;
receiving a plurality of empty bins at the distribution system;
providing objects from the source bins to a collection of processing locations, each processing location including an empty bin of the plurality of empty bins thereby providing the previously empty bins as processed bins when completed; and
moving the processed bins away from the collection of processing locations, wherein the empty bins and the processed bins are each positioned at some point in their respective output paths on a common out-feed conveyor.

36. The method of claim 35, wherein the common out-feed conveyor is a processed bin feed conveyor, and wherein the empty bins cross between processed bins on the processed bin feed conveyor.

37. The method of claim 35, wherein the common out-feed conveyor is an empty bin feed conveyor, and wherein the processed bins cross between empty bins on the empty bin feed conveyor.

38. The method of claim 35, wherein the empty bins and the processed bins are both provided comingled on the common out-feed conveyor.

39. The method of claim 35, wherein the outfeed processing system further includes a processed bin holding conveyor onto which completed bins are moved from the distribution system, said processed bin holding conveyor being in communication with the common out-feed conveyor.

40. The method of claim 39, wherein the distribution system includes a distribution conveyor on which the empty bins are provided for processing, said distribution conveyor being biased to urge the empty bins away from an infeed processing system.

41. The method of claim 40, wherein when a removed processed bin is moved from the distribution conveyor to the processed bin holding conveyor, remaining bins remaining on the distribution conveyor are moved to close a space left by the removed processed bin.
